(19) United States
(12) Patent Application Publication
(10) Pub. No.: US 2012/0151328 A1
(43) Pub. Date: Jun. 14, 2012

(54) COMMUNICATION DEVICE, METHOD OF CONTROLLING COMMUNICATION DEVICE, AND STORAGE MEDIUM

(75) Inventor: Hiroki Matsumoto, Kanagawa (JP)

(73) Assignee: KYOCERA CORPORATION, Kyoto (JP)

(21) Appl. No.: 13/392,138

(22) PCT Filed: Aug. 27, 2010
(86) PCT No.: PCT/JP2010/064629

§ 371 Date: Feb. 24, 2012

(30) Foreign Application Priority Data
Aug. 27, 2009 (JP) 2009-196363

(51) Int. Cl. G06F 17/00

(52) U.S. Cl. 715/234

(57) ABSTRACT

Provided is a communication device including a communication unit which accesses a Web site to receive data of a Web page, a display unit which displays the Web page based on the data received by the communication unit, a control unit which controls the communication unit and the display unit, a storage unit, a registration unit which stores access information for a Web page to be registered, as registration access information in the storage unit, and a history unit which stores access information for a Web page displayed on the display unit as history access information in the storage unit. The control unit displays the registration access information and the history access information stored in the storage unit on the display unit so as to be associated with each other.

### TECHNICAL FIELD

The present invention relates to a communication device having a Web browsing function and a method of controlling a communication device.

### BACKGROUND ART

In recent years, with the rapid development of information and communication technology, communication devices provided with Web browsers capable of performing Internet browsing have been widely spread.

For example, a Web browser has been known which has a bookmark function allowing the user to register the access information of an arbitrary Web page. Further, as disclosed in JP-A-2007-058357, a Web browser has been known which has a history display function of displaying the history of the Web page browsed by the user.

### SUMMARY OF THE INVENTION

### Problem to be Solved by the Invention

However, in the Web browser disclosed in JP-A-2007-058357, it is difficult for the user to easily find a desired Web page from the history.

A communication device is desired, in which a desired Web page can be easily found using a Web page browsing history and bookmark registration.

### Means for Solving the Problem

A communication device according to a first aspect of the present invention comprises: a communication unit which accesses a Web site to receive data of Web page; a display unit which displays the Web page based on the data received by the communication unit; a control unit which controls the communication unit and the display unit; a storage unit; a registration unit which stores access information for a Web page to be registered, as registration access information in the storage unit; and a history unit which stores access information for a Web page displayed on the display unit as history access information in the storage unit. The control unit displays the registration access information and the history access information stored in the storage unit on the display unit so as to be associated with each other.

In the above communication device, when displaying the registration access information and the history access information stored in the storage unit on the display unit so as to be associated with each other, the control unit may display one of the registration access information and the history access information stored in the storage unit on the display unit and may display, on the display unit, extracted access information which is extracted as information associated with the displayed one of the access information from the other of the registration access information and the history access information stored in the storage unit, so as to be associated with the displayed one of the access information.

The above communication device may further comprise a determining unit which determines one of the displayed registration access information and the history access information, and the control unit may control the communication unit to access a Web site to receive a Web page based on the access information determined by the determining unit.

In the above communication device, when displaying the registration access information and the history access information stored in the storage unit on the display unit so as to be associated with each other, the control unit may display the registration access information stored in the storage unit on the display unit, and may display, on the display unit, extracted access information which is extracted as information associated with the displayed registration access information from the history access information stored in the storage unit, so as to be associated with the displayed registration access information.

In the above communication device, the control unit may extract, as the extracted access information, history access information having a domain name same as that of the registration access information displayed on the display unit.

In the above communication device, the control unit may extract a plurality of history access information as the extracted access information, and the control unit may display on the display unit, among a plurality of extracted access information, the extracted access information corresponding to a Web page, data of which is received newer, prior to the extracted access information corresponding to a Web page, data of which is received older, so as to be associated with the displayed registration access information.

In the above communication device, the storage unit may store data of a Web page received by the communication unit as temporary storage data, the control unit may extract a plurality of history access information as the extracted access information, and the control unit may display on the display unit, among a plurality of extracted access information, the extracted access information corresponding to a Web page, data of which remains in the storage unit, prior to the extracted access information corresponding to a Web page, data of which does not remain in the storage unit, so as to be associated with the displayed registration access information.

In the above communication device, the control unit may extract a plurality of history access information as the extracted access information, and the control unit may display on the display unit, among a plurality of extracted access information, the extracted access information corresponding to a Web page which is displayed on the display unit a larger number of times, prior to the extracted access information corresponding to a Web page which is displayed on the display unit a smaller number of times, so as to be associated with the displayed registration access information.

In the above communication device, the control unit may extract a plurality of history access information as the extracted access information, and the control unit may display on the display unit, among a plurality of extracted access information, the extracted access information corresponding to a Web page which is displayed on the display unit for a longer time, prior to the extracted access information corresponding to a Web page which is displayed on the display unit for a shorter time, so as to be associated with the displayed registration access information.

In the above communication device, the control unit may extract a plurality of history access information as the extracted access information, and the control unit may display on the display unit, among a plurality of extracted access information, the extracted access information corresponding to a Web page having a larger amount of information displayed on the display unit for a unit time, prior to the extracted access information corresponding to a Web page having a smaller amount of information displayed on the display unit for the unit time, so as to be associated with the displayed registration access information.

In the above communication device, the storage unit may store a plurality of registration access information, and the display unit may display the plurality of registration access information stored in the storage unit, the communication device may further comprise a selecting unit which selects one of the plurality of displayed registration access information, and when the selecting unit selects one of the plurality of registration access information displayed on the display unit, the control unit may display on the display unit the selected registration access information and extracted access information which is extracted from the history access information stored in the storage unit for the selected registration access information so as to be selectable.

A method of controlling a communication device according to a second aspect of the present invention, which includes a communication unit which accesses a Web site to receive data of a Web page, a display unit which displays the Web page based on the data received by the communication unit, a storage unit, a registration unit which stores access information for a Web page to be registered, as registration access information in the storage unit, and a history unit which stores access information for a Web page displayed on the display unit as history access information in the storage unit, the method comprises: displaying the registration access information and the history access information stored in the storage unit on the display unit so as to be associated with each other.

A storage medium according to a third aspect of the present invention has a program stored thereon and is readable by a computer of a communication device including a communication unit which accesses a Web site to receive data of a Web page, a display unit which displays the Web page based on the data received by the communication unit, a storage unit, a registration unit which stores access information for a Web page to be registered, as registration access information in the storage unit, and a history unit which stores access information for a Web page displayed on the display unit as history access information in the storage unit. When the program is executed by the computer, causing the computer to perform operations comprises displaying the registration access information and the history access information stored in the storage unit on the display unit so as to be associated with each other.

### Effects of the Invention

According to the above-described configuration, a desired Web page can be easily found using registration information and history information of a Web page.

### BRIEF DESCRIPTION OF DRAWINGS

FIG. 1 is a diagram illustrating the outer appearance of a mobile phone according to an embodiment of the present invention.

FIG. 2 is a diagram illustrating the hardware configuration of the mobile phone shown in FIG. 1.

FIG. 3 is a block diagram illustrating functions related to Web browsing.

FIG. 4 is a flowchart illustrating the entire Web browsing process.

FIG. 5 is a flowchart illustrating a browsing process when a bookmark or a sub-menu is selected.

FIG. 6 is a diagram illustrating the display layout of a main selection menu and a sub-selection menu displayed on a display unit shown in FIG. 2.

### DESCRIPTION OF EMBODIMENTS

Hereinafter, embodiments of the present invention will be described with reference to the accompanying drawings.

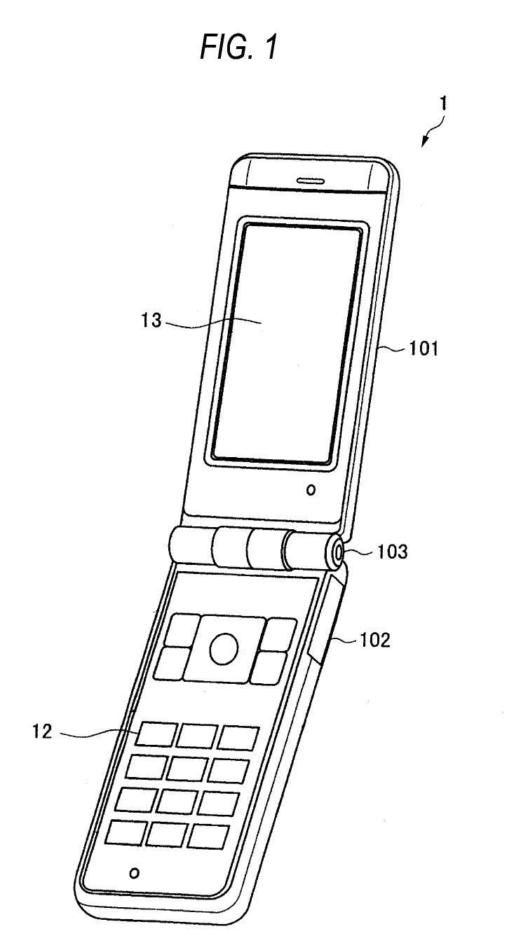

FIG. 1 is a diagram illustrating the outer appearance of a mobile phone 1 according to an embodiment of the present invention.

The mobile phone 1 includes an upper housing 101, a lower housing 102, and a hinge portion 103. The upper housing 101 and the lower housing 102 have rectangular shapes with substantially the same size. The upper housing 101 and the lower housing 102 are connected to each other to be opened and closed by the hinge portion 103. FIG. 1 shows the opened state of the upper housing 101 and the lower housing 102. A display unit 13 is provided in the upper housing 101. An operation unit (an example of a determining unit and a selecting unit) 12 is provided in the lower housing 102.

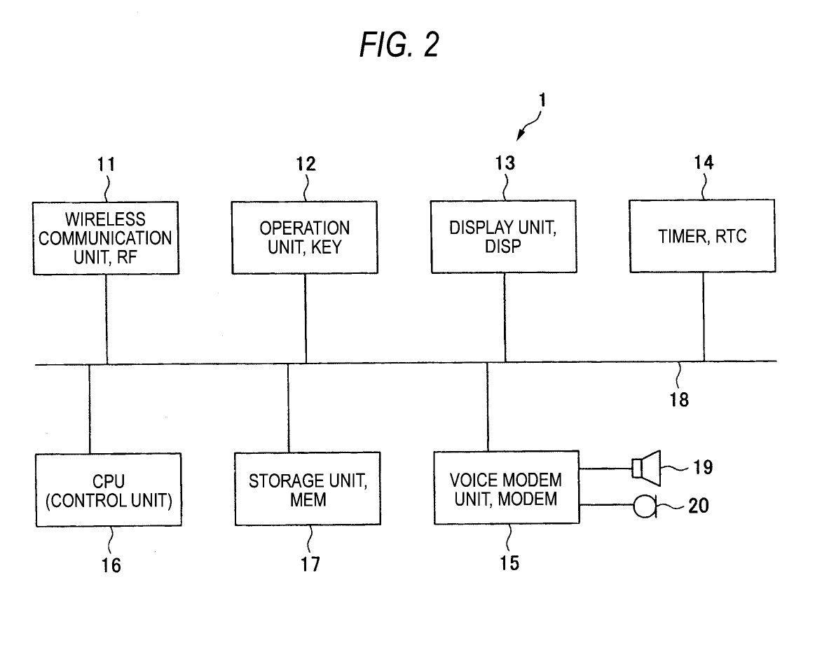

FIG. 2 is a diagram illustrating the hardware configuration of the mobile phone 1 shown in FIG. 1.

The mobile phone 1 includes, for example, a wireless communication unit (RF) 11, the operation unit (KEY) 12, the display unit (DISP) 13, a timer (RTC) 14, a voice modem unit (MODEM) 15, a CPU (Central Processing Unit) 16, a storage unit (MEM) 17, and a system bus 18 which connects the above-mentioned components.

The wireless communication unit 11 establishes a communication channel with a base station (not shown) and transmits or receives communication data to or from the base station. Specifically, the wireless communication unit 11 wirelessly transmits communication data included in a signal input from the CPU 16 to the base station. In addition, the wireless communication unit 11 outputs a signal including communication data received from the base station to the CPU 16.

Examples of the communication data include transmission data which is transmitted from the wireless communication unit 11 to the base station and received data which is received by the wireless communication unit 11 from the base station.

The transmission data includes, for example, a request to transmit Web page data of a Web site in Web browsing. The transmission request includes, for example, a URL (Uniform Resource Locator) indicating the location of a requested Web site. The received data includes, for example, Web page data of a requested Web site.

The display unit 13 includes an LCD (Liquid Crystal Display Device) or an organic EL (Electro-Luminescence) device (not shown). The LCD or the organic EL device is provided in the upper housing 101 of the mobile phone 1, as shown in FIG. 1. The display unit 13 displays display data included in the signal which is input from the CPU 16. For example, the display unit 13 displays the Web page or the URL received by the wireless communication unit 11.

The operation unit 12 includes a plurality of operation keys. The plurality of operation keys include, for example, a function key, a power key, a call key, numerical keys, character keys, and a send key. As shown in FIG. 1, the operation keys are arranged in the lower housing 102 of the mobile phone 1. The operation unit 12 outputs a signal corresponding to the operation key operated by the user to the CPU 16.

The voice modem unit 15 is connected to a speaker 19 and a microphone 20. The voice modem unit 15 samples a voice input to the microphone 20 and outputs a signal including voice data to the CPU 16. In addition, the voice modem unit 15 drives the speaker 19 based on voice data included in the signal input from the CPU 16. In this way, the speaker 19 outputs a voice corresponding to the voice data.

The timer 14 measures time and an elapsed time. Then, the timer 14 outputs a signal including time information to the CPU 16. In addition, the timer 14 outputs an interrupt signal to the CPU 16 at a set time or an elapsed time included in the signal input from the CPU 16.

The storage unit 17 stores, for example, programs which can be read and executed by the CPU 16 and data used by the CPU 16. The programs stored in the storage unit 17 may be installed from a computer-readable recording medium, such as a CD-ROM (Compact Disc Read Only Memory). The programs stored in the storage unit 17 may be downloaded through a transmission medium, such as the Internet, and then installed.

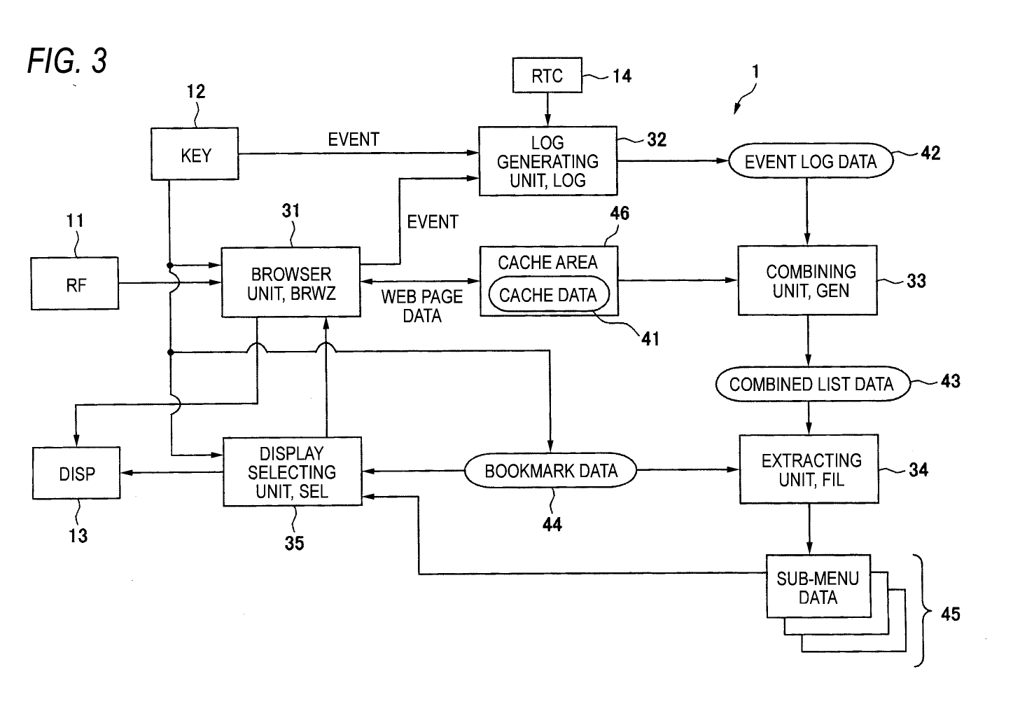

As shown in FIG. 3, which will be described below, examples of the data stored in the storage unit 17 include cache data 41, event log data 42, combined list data (history access information) 43, bookmark data (registration access information) 44, and sub-menu data 45 for each bookmark.

The cache data (temporarily stored data) 41 is stored in a cache area 46 of the storage unit 17. The cache area 46 has a predetermined capacity. When the cache area 46 is full, oldest data is deleted in order from the cache area 46.

The bookmark data 44 includes access information to a Web site for a plurality of Web pages. For the access information to each Web site, for example, when the user uses the operation unit 12 to register the Web page which is being browsed, the control unit registers the Web page in the bookmark data 44, and the access information to the Web site for the Web page is stored in the storage unit 17. In this way, a target Web page is registered as a bookmark. The access information is any information as long as indicating the location of the Web site. In addition to the above-mentioned URL, for example, an IP address may be registered as the access information. The registration of the bookmark also includes the registration of the Web page as a “favorite”.

The CPU 16 is an arithmetic processing unit which executes programs. The CPU 16 executes the program stored in the storage unit 17 to implement a control unit which controls the operation of the mobile phone 1.

FIG. 3 is a block diagram illustrating functions related to Web browsing which are implemented in the mobile phone 1.

The CPU 16 implements the functions of a browser unit (BRWZ) 31, a log generating unit (LOG) 32, a combining unit (GEN) 33, an extracting unit (FIL) 34, a display selecting unit (SEL) 35 in association with Web browsing.

The browser unit 31 is operated to enable the user to perform Web browsing.

A signal for selecting a Web page to be displayed is input from the operation unit 12 to the browser unit 31. Then, the browser unit 31 outputs a request to transmit the Web page indicated by the input to the wireless communication unit 11. The wireless communication unit 11 transmits the request to transmit the Web page to the base station.

The browser unit 31 designates a URL, which is access information to a Web site of the Web page which is selected and determined by the operation unit 12 from, for example, display data displayed on the display unit 13, based on the transmission request. The URL is configured by a combination of, for example, the domain name of a server, a folder name, and a file name.

In addition, the browser unit 31 transmits a request to transmit display data including the access information input from the display selecting unit 35 to the wireless communication unit 11.

When the requested data is received by the wireless communication unit 11, the browser unit 31 generates the cache data 41 based on the received data and stores the cache data 41 in the storage unit 17. The storage unit 17 stores files for each cache data 41. The files of each cache data 41 include, for example, the received data, the time when the data is received, or the time when the cache data 41 is acquired.

When all of data required to display the requested Web page is received, the browser unit 31 reads the data from the cache data 41, generates Web page display data, and outputs the Web page display data to the display unit 13. The browser unit 31 may start the generation of the display data at the time when the reception of data required to display the display range of the display unit 13 ends and display the display data on the display unit 13.

The log generating unit 32 generates the event log data 42 occurred by the CPU 16. The log generating unit 32 stores, for example, an operation event of the operation unit 12, a display event of the display unit 13, and transmission/reception events by the browser unit 31 in the event log data 42 in order of the time of occurrence.

The event log data 42 has, for example, records for each event. The record includes information, such as the content of the event and the event occurrence time measured by the timer 14.

The combining unit 33 generates the combined list data 43 from the event log data 42 and the cache data 41.

The combined list data 43 has, for example, records for each Web page browsed by the browser unit 31 and access information to each Web site recorded as access history information to the Web site of each Web page.

The record of each Web page includes the following information:

(a) The URL of the Web page;

(b) The title of the Web page designated by a <title>tag;

(c) Access time to the Web site of the Web page;

(d) An access method to the Web site of the Web page;

(e) The display time of the Web page;

(f) The time when the last operation is performed on the Web page;

(g) The total amount of data downloaded for the Web page;

(h) The amount of data of readable text in the Web page;

(i) The sum of the amounts of data of images in the Web page;

(j) The amount of data of an image with the maximum amount of data in the Web page;

(k) The number of pixels of an image with a maximum number of pixels in the Web page; and

(l) The rendering size (the number of pixels in the vertical and horizontal directions) of the entire Web page.

Specifically, the combining unit 33 arranges each event in the event log data 42 and each cache data 41 in time series and combines them. The combining unit 33 adds the above-mentioned various kinds of information to the records for each Web page based on the time order in the generated time-series list.

For example, the combining unit 33 adds the time of the transmission request event immediately before receiving the data of the Web page, as (c) the access time to the Web page.

As (d) the access method to the Web page, the combining unit 33 adds the display switching event immediately before receiving the data of the Web page. That is, (d) the access method to the Web page is the detailed content of the event leading to the display of the Web page. Specifically, for example, any one of the access methods, such as a transition by a link, a transition by a backward/forward movement operation, a transition by the selection of a form, a transition by redirection, a transition by script, and a transition by the direct input of a URL, is stored.

The combining unit 33 calculates the time from the output of a first display data of the Web page to the output of a first display data of the next Web page and adds the calculated time as (e) the display time of the Web page.

The combining unit 33 adds the time of an operation event immediately before a switching event of the Web page as (f) the time when the last operation is performed on the Web page.

Accordingly, the combined list data 43 is generated.

The extracting unit 34 generates a plurality of sub-menu data 45 for each bookmark registered in the bookmark data, from the bookmark data 44 and the combined list data 43. The sub-menu data 45 includes data of the Web page which is associated with the Web site of a Web page registered as the bookmark, among the Web pages which are stored as a browsing history in the combined list data 43. In addition, the sub-menu data 45 may include data of a displayed page of another Web site which is moved from the Web site of the Web page registered as a bookmark.

Each Web site includes an upper-layer Web page corresponding to a main URL and a plurality of lower-layer Web pages linked from the upper-layer Web page. In general, a plurality of Web pages of the Web site includes a domain name common to the URL of the main upper-layer Web page. Therefore, when the browser unit 31 displays a plurality of Web pages of a predetermined Web site, the sub-menu data 45 is generated to include the access information of the plurality of Web pages.

Specifically, the extracting unit 34 extracts, for example, records including a portion (domain name) of the access information to each bookmarked Web page from the combined list data 43. Then, the extracting unit 34 performs a filtering process, which will be described below, on each of the extracted records and adds, for example, the access information of the remaining records after the filter process to the sub-menu data 45. In addition, the extracting unit 34 rearranges a plurality of access information included in the sub-menu data 45 after the addition process and deletes unnecessary data. In this way, the sub-menu data 45 is generated for each bookmark.

The display selecting unit 35 displays the bookmark data 44 and the sub-menu data 45 on the display unit 13. Specifically, the display selecting unit 35 displays a plurality of bookmarks included in the bookmark data 44 on the display unit 13 such that each of the bookmarks can be selected. When the operation unit 12 is operated to select one of the displayed bookmarks, the selected bookmark is focused such that the user can recognize the selected state. Then, the display selecting unit 35 displays the sub-menu data 45 of the selected bookmark on the display unit 13 such that each sub-menu can be selected.

When the operation unit 12 is operated to select one of the sub-menus which are displayed so as to correspond to the selected bookmark and a decision operation is performed, the display selecting unit 35 outputs the access information of the sub-menu whose selection has been decided to the browser unit 31. In addition, when the decision operation is performed with the bookmark being selected, without selecting the sub-menu, even though the sub-menus corresponding to the selected bookmark are displayed, the display selecting unit 35 outputs the access information of the bookmark whose selection has been decided to the browser unit 31. That is, the display selecting unit 35 outputs the access information corresponding to the bookmark or the sub-menu decided by the operation unit 12 to the browser unit 31.

The sub-menus are displayed so as to correspond to the selected bookmark. However, the sub-menus may be displayed so as to correspond to all of the displayed bookmarks.

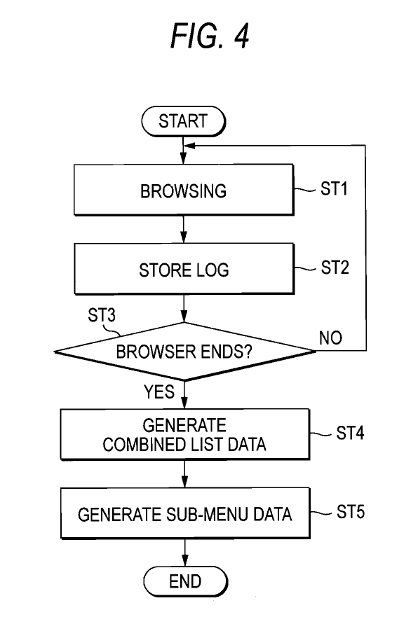

FIG. 4 is a flowchart illustrating the entire process related to Web browsing by the mobile phone 1 shown in FIG. 1.

In the Web browsing, the browser unit 31 transmits a request to transmit the display data of a Web page based on the operation of the operation unit 12 from the wireless communication unit 11. When the requested data is received by the wireless communication unit 11, the browser unit 31 stores the received data as the cache data 41 in the storage unit 17. In addition, the browser unit 31 reads download data from the cache data 41, generates the display data of the Web page, and displays the display data on the display unit 13 (Step ST1).

The log generating unit 32 stores and stores the event data occurred by, for example, the operation unit 12 and the browser unit 31 in the event log data 42 (Step ST2).

The combining unit 33 determines whether the Web browsing ends (Step ST3).

The combining unit 33 repeatedly performs the determination in Step ST3 until the Web browsing ends.

For example, when the operation unit 12 is used to input an operation of ending the operation of the browser unit 31, the combining unit 33 generates the combined list data 43 from the event log data 42 of the event occurred during the Web browsing and the cache data 41 (Step ST4).

The extracting unit 34 generates the sub-menu data 45 for each bookmark from the bookmark data 44 and the combined list data 43 (Step ST5).

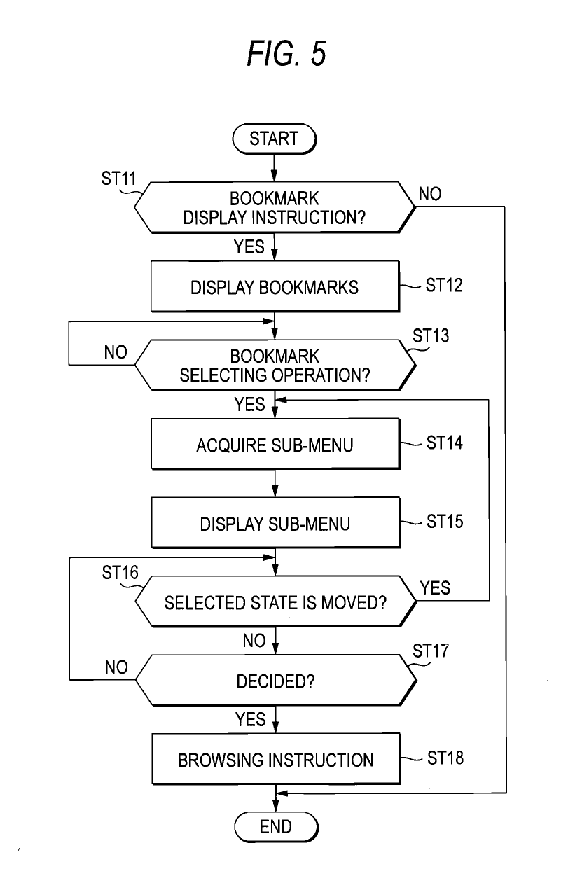

FIG. 5 is a diagram illustrating a Web browsing operation when the bookmark or the sub-menu is selected.

The display selecting unit 35 determines whether there is a bookmark display instruction input from the operation unit 12 (Step ST11).

When there is a bookmark display instruction, the display selecting unit 35 reads the bookmark data 44 stored in the storage unit 17, generates the display data of the main selection menu in which a plurality of bookmarks are arranged such that each of the bookmarks can be selected, and displays the display data on the display unit 13 such that a list of the bookmarks is displayed on the display unit 13 (Step ST12).

In addition, the display selecting unit 35 determines whether there is an operation of selecting the bookmark (Step ST13).

When the operation unit 12 is used to select one bookmark from the main selection menu, the display selecting unit 35 acquires the sub-menu data 45 associated with the selected bookmark (Step ST14).

In addition, the display selecting unit 35 reads the acquired sub-menu data 45, generates the display data of the sub-selection menu in which a plurality of access information are arranged so as to be selectable for the selected bookmarks, and displays the display data on the display unit 13 (Step ST15).

When the operation unit 12 is used to select another bookmark, the display selecting unit 35 determines that the selected state is moved in Step ST16.

When it is determined that the selected state is moved, the process returns to Step ST14 and the display selecting unit 35 acquires the sub-menu data 45 associated with the bookmark selected after switching. Then, the display selecting unit 35 generates the display data of a new sub-selection menu in which access information are arranged so as to be selectable for the selected bookmark and displays the display data on the display unit 13 (Step ST15).

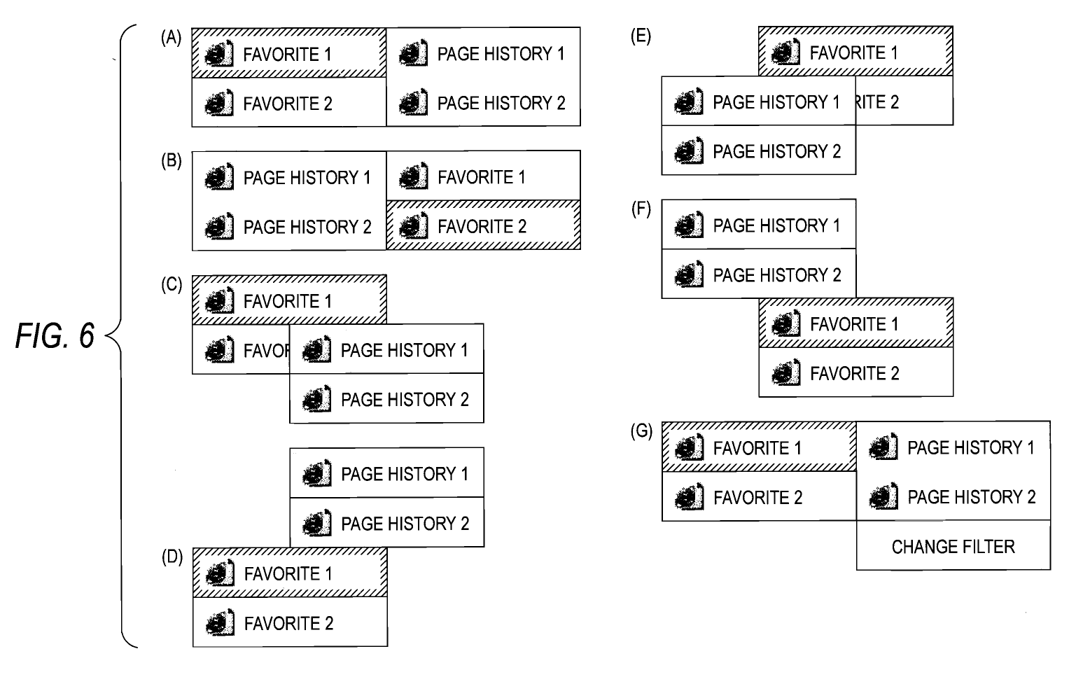

FIG. 6 is a diagram illustrating the display layout of the main selection menus and the sub-selection menus displayed on the display unit 13. FIG. 6 shows examples of combinations of the main selection menus of two bookmarks and the sub-selection menus of two access information.

In FIG. 6(A), the sub-selection menu is displayed on the right side of the main selection menu.

In FIG. 6(B), the sub-selection menu is displayed on the left side of the main selection menu.

In FIG. 6(C), the sub-selection menu is displayed so as to overlap a lower right portion of the main selection menu.

In FIG. 6(D), the sub-selection menu is displayed so as to overlap an upper right portion of the main selection menu.

In FIG. 6(E), the sub-selection menu is displayed so as to overlap a lower left portion of the main selection menu.

In FIG. 6(F), the sub-selection menu is displayed so as to overlap an upper left portion of the main selection menu.

Returning to FIG. 5, the display selecting unit 35 determines whether the operation unit 12 is used to perform an operation of deciding the selected bookmark or sub-selection menu, among the displayed bookmarks or sub-selection menus (Step ST17).

For example, when the selected bookmark or sub-selection menu is decided, the display selecting unit 35 outputs the access information corresponding to the decided bookmark or sub-selection menu to the browser unit 31 (Step ST18). The browser unit 31 transmits a request to transmit data, which includes the access information corresponding to the bookmark or sub-selection menu decided by the display selecting unit 35 from the wireless communication unit 11.

In addition, when the requested data is received by the wireless communication unit 11, the browser unit 31 stores the received data as the cache data 41 in the storage unit 17. The browser unit 31 reads download data from the cache data 41, generates the display data of the Web page, and displays the display data on the display unit 13. Accordingly, the Web page corresponding to the decided bookmark or sub-selection menu is displayed on the display unit 13.

That is, in this embodiment, the bookmark and the information of the previously browsed Web page are displayed so as to be associated with each other. Therefore, when the bookmark is displayed, it is possible to easily select the bookmark and the page associated with the bookmark.

In this embodiment, for example, when there is a transition from the bookmarked (favorite) Web page to another Web page and the bookmark is displayed and selected, the browsed Web page associated with the bookmarked Web page is displayed in the sub-selection menu. Therefore, the user can display the registered bookmarked Web page and the Web page previously moved from the bookmarked Web page.

For example, the user can easily select a Web page which is associated with the bookmarked Web page and is not registered as the bookmark, as compared to a case in which a browsing history is simply displayed on the display unit 13 and is then selected, or a case in which the browsing history is displayed while being arranged according to each item, and is then selected.

Therefore, this embodiment is effective in the following cases.

For example, this embodiment is effective in a case in which the user wants to again browse the Web page which has been browsed once, when the user does not know the URL of the Web page, when the Web page is not registered as a bookmark, and when a search keyword for facilitating a search for the Web page is not remembered.

In addition, this embodiment is effective in a case in which the Web page is not a search target of the search engine and is not searched and a case in which the user does not remember the link to the Web page.

The user registers the Web page which is considered to be important as the bookmark.

However, if a temporarily favorite Web page is registered as the bookmark, the amount of bookmark registration data increases enormously.

It takes a lot of time and effort to search for the bookmark of a target Web page from such enormous amount of bookmark data. Therefore, the user restrains the registration of the Web site as the bookmark as the number of bookmarks registered increases.

This embodiment has a great effect when the user wants to browse again the Web page which is not registered as the bookmark and has been browsed once, under the above usage conditions.

Next, the filtering process of the extracting unit 34 will be described in detail. As described above, the filtering process is performed on the record which includes access information to each bookmarked Web page and is extracted from the combined list data 43.

The combined list data 43 generated by the combining unit 33 has the above-mentioned information (a) to (l) in the record for each Web page. The extracting unit 34 performs, for example, the following filtering process based on the information (a) to (l).

First, it is considered that the filtering process is performed such that a Web page including the latest access information is obtained from the combined list data 43. In this way, it is possible to preferentially display the latest browsed Web page so as to be associated with the bookmark.

In addition, the filtering process may be performed such that a Web page which is accessed frequently (for example, two or more times) and browsed is obtained from the combined list data 43. In this way, it is possible to preferentially display a portal-like Web page which is frequently browsed by the user so as to be associated with the bookmark.

The filtering process may be performed such that a Web page corresponding to a leaf page (a page from which the user does not advance to a new page, but returns to the previous page) is obtained. In this way, it is possible to preferentially display an information page before the portal-like Web page so as to be associated with the bookmark.

The filtering process may be performed such that a Web page which is displayed for a period of time longer than a predetermined period of time or a Web page which is displayed for a period of time longer than an average display time is obtained. In this way, it is possible to preferentially display the Web page that the user is interested in so as to be associated with the bookmark.

The filtering process may be performed such that a Web page which is displayed by directly selecting a link in the page is not obtained. In this way, a screen which is not useful for the user, such as a confirmation screen, cannot be displayed.

The filtering process may be performed such that a Web page which is displayed by a GET method is obtained. In this way, for example, the confirmation screen cannot be displayed while a search result screen is displayed.

The filtering process may be performed based on the total amount of data downloaded for a Web page such that a Web page for which the total amount of downloaded data is larger is obtained. In this way, it is possible to preferentially display a page with a large amount of information so as to be associated with the bookmark.

The filtering process may be performed based on the amount of data of readable text in the Web page such that a Web page in which the amount of data of readable text is larger is obtained. In this way, it is possible to preferentially display a page with a large amount of information so as to be associated with the bookmark.

The filtering process may be performed based on the sum of the amounts of data of images in the Web page such that a Web page with a large amount of image data is obtained. In this way, it is possible to preferentially display a page with a large amount of information so as to be associated with the bookmark.

The filtering process may be performed based on the amount of data of an image with the maximum amount of data in the Web page such that a Web page in which one image has a large amount of data is obtained. In this way, it is possible to preferentially display a page with a large amount of information so as to be associated with the bookmark.

The filtering process may be performed based on the amount of data of the image with the maximum amount of data in the Web page such that a Web page in which one image has a large number of pixels is obtained. In this way, it is possible to preferentially display a page with a large amount of information so as to be associated with the bookmark.

The filtering process may be performed based on the amount of data of readable text in the Web page and the display time of the Web page such that a Web page in which a display time per character in readable text is longer than a predetermined period of time or an average time is obtained. In this way, it is possible to preferentially display the page that the user is interested in so as to be associated with the bookmark.

The filtering process may be performed based on the sum of the amounts of data of images in the Web page and the display time of the Web page such that a Web page in which the display time of a predetermined number of pixels in an image is longer than a predetermined period of time or an average time is obtained. In this way, it is possible to preferentially display the page that the user is interested in so as to be associated with the bookmark.

The filtering process may be performed based on the rendering size of the entire Web page (the number of pixels in the horizontal and vertical directions) such that a Web page in which the display time of the total number of pixels in the entire page is longer than a predetermined period of time or an average time is obtained. In this way, it is possible to preferentially display the page that the user is interested in so as to be associated with the bookmark.

The filtering process may be performed based on the URL of a Web page such that a Web page with the same domain (URL) as that of a bookmarked Web page is obtained. In addition, the filtering process may be performed such that a Web page which is included in one or a plurality of domains designated for the bookmark is obtained. In this way, it is possible to preferentially display the page that the user is interested in so as to be associated with the bookmark.

The filtering process may be performed based on the access time to the Web page such that a Web page which is accessed within a specific period of time (for example, today, yesterday, within one week, or within one month) is obtained. In this way, it is possible to preferentially display the latest page which is accessed so as to be associated with the bookmark.

The filtering process may be performed based on the display time of the Web page such that a Web page which is displayed for a period of time shorter than a predetermined period of time is not obtained. In this way, it is possible to prevent the display of the page which is displayed but not actually viewed by the user.

The filtering processes with different characteristics may be performed on each bookmark. In this way, it is possible to optimize the display of the Web page.

As described above, in this embodiment, even when the user does not register the Web page which has been actually browsed as the bookmark, it is possible to display the Web page which is considered to be likely to be registered as the bookmark so as to be associated with the bookmark. Therefore, the user can easily browse the Web page that the user wants to browse again.

For example, when the top page of a portal site which provides various kinds of information, such as news and an auction, is registered as a bookmark, the Web sites used by the user, such as a news site and an auction site, are displayed so as to be selectable, similarly to the bookmark.

Therefore, when the number of times the user uses the portal site is two or more, the user can directly browse the Web page of the news site or the auction site from the sub-selection menu associated with the Web page which is registered as a bookmark, not from the top page of the portal site including the Web page which is registered as a bookmark.

In this embodiment, the Web page in which the user is considered to be interested and the bookmark are displayed at the same time. Therefore, a re-recognition effect on the user is obtained and it is possible to assist the intellectual activity of the user.

In this embodiment, the Web page in which the user is considered to be interested is filtered and displayed. Therefore, the amount of noise is reduced and it is easy to find an effective page.

In this embodiment, since the bookmark is dynamically updated, it can follow a change in the taste of the user.

In this embodiment, since a page, such as a simple confirmation screen, is excluded, the work efficiency of the user is improved.

In this embodiment, the history which is systemically arranged can be referred to during an operation for a series of bookmarks. Therefore, the operation procedure is omitted and convenience is improved, as compared to prior-art user interface in which the bookmark is separated from the history.

The above-described embodiment is an example of preferred embodiments of the present invention, and the present invention is not limited thereto. Various modifications and changes in the present invention can be made without departing from the scope and spirit of the present invention.

For example, in the above-described embodiment, a plurality of bookmarks included in the bookmark data 44 is first displayed such that each of bookmarks can be selected. When one of the bookmarks is selected, the sub-menu data 45 corresponding to the selected bookmark is displayed. However, for example, the records of the Web pages included in the combined list data 43 may be displayed such that each of the records can be selected. When one of the records is selected, the bookmark corresponding to the selected record may be displayed so as to be selectable.

In this case, the extracting unit 34 does not generate the sub-menu data 45 from the combined list data using each bookmark as a key, but may extract the bookmark in which the Web page similarly associated with each record is registered from the bookmark data 44 using each record as a key and generate the sub-menu data from the bookmark data 44 and the combined list data 43.

In the above-described embodiment, the combining unit 33 generates the combined list data 43 for all of the Web pages of the cache data 41.

Further, the extracting unit 34 basically extracts all of the Web pages of the combined list data 43 to the sub-menu data 45. As another example, the maximum number of data items in the combined list data 43 or the sub-menu data 45 may be limited. In this way, the amount of data used in the storage unit 17 may be limited.

In the above-described embodiment, the extracting unit 34 adds the access information of the newly extracted Web page to the sub-menu data 45. As another example, the extracting unit 34 may update the sub-menu data 45 using the access information of the newly extracted Web page. In addition, the extracting unit 34 may set the storage period of the access information of each Web page in the sub-menu data 45 and delete the access information whose storage period has elapsed.

In the above-described embodiment, the display unit 13 displays the access information of each Web page in the sub-menu data 45 with text. As another example, the display unit 13 may display the access information of each Web page in the sub-menu data 45 with a Web page shortcut icon. In this case, the icon may be registered in the record of each Web page in the sub-menu data 45.

In the above-described embodiment, the sub-menu data 45 is stored as data which is independent from the bookmark data 44 in the storage unit 17. As another example, the sub-menu data 45 may be stored as data associated with the bookmark data 44 in the storage unit 17. As such, in the structure in which data items are associated with each other, for example, when a bookmark is deleted from the bookmark data 44, the sub-menu data 45 associated with the bookmark may also be deleted. When the previously deleted bookmark is registered again, the previous sub-menu data 45 which has been stored without being deleted may be associated with the re-registered bookmark.

In the above-described embodiment, the extracting unit 34 generates the sub-menu data 45 for each bookmark from the combined list data 43. As another example, the combining unit 33 may separately generate a summary of the list, in addition to the combined list data 43. The summary may include, for example, the following items:

(a) A page which appears most frequently and the number of appearances of the page;

(b) A page which is displayed for a maximum period of time and the display time of the page;

(c) An average display time;

(d) A page with the maximum amount of data and the amount of data of the page; and

(e) A position in the list where a specific time, such as, today, yesterday, a week ago, or a month ago, starts.

Since the extracting unit 34 uses both the summary and the combined list data 43, it is possible to reduce the time required to generate the sub-menu data 45 for each bookmark. Alternatively, the extracting unit 34 may use only the summary to generate the sub-menu data 45 for each bookmark.

In the above-described embodiment, the display selecting unit 35 displays the main selection menu and the sub-menu on the display unit 13. As another example, as shown in FIG. 6(G), the display selecting unit 35 may display an item for changing the settings of a filter on the display unit 13 in the same category as the history by the sub-menu. Examples of the item include the options of the filter used and a link, which is an entrance to a change in settings.

When the sub-menu is displayed, the display selecting unit 35 may display the sub-menu data 45 for each bookmark in different ways when there is the cache data 41 and when there is no cache data 41.

In the above-described embodiment, the extracting unit 34 performs the filtering process to select the extracted Web page from the browsed Web pages. As another example, the extracting unit 34 may rearrange the browsed Web pages in the sub-menu data 45 according to priority obtained by the same process as the filtering process.

In the above-described embodiment, (f) the time when the last operation is performed on the Web page is stored in the combined list data 43. In this way, the time when the last operation other than a page switching operation, for example, a scroll operation is performed is stored in the combined list data 43. As another example, the content of the operation in the page, the number of operations in the page, the content of the last operation which is performed several times, or the time may be stored in the combined list data 43. The extracting unit 34 may perform the filtering process based on these information.

In the above-described embodiment, in the mobile phone 1, the functions of the browser unit 31 and the mail creating unit 51 are implemented. In addition, for example, the present invention can be applied to communication devices, such as a PHS (Personal Handy phone System) terminal, a personal computer terminal, a PDA (Personal Data Assistance), and a portable game machine.

This application is based on Japanese Patent Application No 2009-196363 filed on Aug. 27, 2009, the content of which is hereby incorporated by reference.

### DESCRIPTIONS OF REFERENCE NUMERALS

1: mobile phone (communication device)
11: wireless communication unit (communication unit)
12: operation unit (determining unit, selecting unit)
13: display unit
16: CPU (control unit, registration unit, history unit)
17: storage unit
31: browser unit
32: log generating unit
33: combining unit
34: extracting unit
35: display selecting unit
41: cache data (temporary storage data)
43: combined list data (history access information)
44: bookmark data (registration access information)

1. A communication device comprising:
a communication unit which accesses a Web site to receive data of Web page;
a display unit which displays the Web page based on the data received by the communication unit;
a control unit which controls the communication unit and the display unit;
a storage unit;
a registration unit which stores access information for a Web page to be registered, as registration access information in the storage unit; and
a history unit which stores access information for a Web page displayed on the display unit as history access information in the storage unit,
wherein the control unit displays the registration access information and the history access information stored in the storage unit on the display unit so as to be associated with each other.

2. The communication device according to claim 1,
wherein, when displaying the registration access information and the history access information stored in the storage unit on the display unit so as to be associated with each other, the control unit displays one of the registration access information and the history access information stored in the storage unit on the display unit and displays, on the display unit, extracted access information which is extracted as information associated with the displayed one of the access information from the other of the registration access information and the history access information stored in the storage unit, so as to be associated with the displayed one of the access information.

3. The communication device according to claim 2, further comprising:
a determining unit which determines one of the displayed registration access information and the history access information,
wherein the control unit controls the communication unit to access a Web site to receive a Web page based on the access information determined by the determining unit.

4. The communication device according to claim 3,
wherein, when displaying the registration access information and the history access information stored in the storage unit on the display unit so as to be associated with each other, the control unit displays the registration access information stored in the storage unit on the display unit, and displays, on the display unit, extracted access information which is extracted as information associated with the displayed registration access information from the history access information stored in the storage unit, so as to be associated with the displayed registration access information.

5. The communication device according to claim 4,
wherein the control unit extracts, as the extracted access information, history access information having a domain name same as that of the registration access information displayed on the display unit.

6. The communication device according to claim 4,
wherein the control unit extracts a plurality of history access information as the extracted access information, and
wherein the control unit displays on the display unit, among a plurality of extracted access information, the extracted access information corresponding to a Web page, data of which is received newer, prior to the extracted access information corresponding to a Web page, data of which is received older, so as to be associated with the displayed registration access information.

7. The communication device according to claim 4,
wherein the storage unit stores data of a Web page received by the communication unit as temporary storage data,
wherein the control unit extracts a plurality of history access information as the extracted access information, and
wherein the control unit displays on the display unit, among a plurality of extracted access information, the extracted access information corresponding to a Web page, data of which remains in the storage unit, prior to the extracted access information corresponding to a Web page, data of which does not remain in the storage unit, so as to be associated with the displayed registration access information.

8. The communication device according to claim 4,
wherein the control unit extracts a plurality of history access information as the extracted access information, and
wherein the control unit displays on the display unit, among a plurality of extracted access information, the extracted access information corresponding to a Web page which is displayed on the display unit a larger number of times, prior to the extracted access information corresponding to a Web page which is displayed on the display unit a smaller number of times, so as to be associated with the displayed registration access information.

9. The communication device according to claim 4,
wherein the control unit extracts a plurality of history access information as the extracted access information, and
wherein the control unit displays on the display unit, among a plurality of extracted access information, the extracted access information corresponding to a Web page which is displayed on the display unit for a longer time, prior to the extracted access information corresponding to a Web page which is displayed on the display unit for a shorter time, so as to be associated with the displayed registration access information.

10. The communication device according to claim 4,
wherein the control unit extracts a plurality of history access information as the extracted access information, and
wherein the control unit displays on the display unit, among a plurality of extracted access information, the extracted access information corresponding to a Web page having a larger amount of information displayed on the display unit for a unit time, prior to the extracted access information corresponding to a Web page having a smaller amount of information displayed on the display unit for the unit time, so as to be associated with the displayed registration access information.

11. The communication device according to claim 4,
wherein the storage unit stores a plurality of registration access information, and
wherein the display unit displays the plurality of registration access information stored in the storage unit,
the communication device further comprising:
a selecting unit which selects one of the plurality of displayed registration access information,
wherein when the selecting unit selects one of the plurality of registration access information displayed on the display unit, the control unit displays on the display unit the selected registration access information and extracted access information which is extracted from the history access information stored in the storage unit for the selected registration access information so as to be selectable.

12. A method of controlling a communication device including a communication unit which accesses a Web site to receive data of a Web page, a display unit which displays the Web page based on the data received by the communication unit, a storage unit, a registration unit which stores access information for a Web page to be registered, as registration access information in the storage unit, and a history unit which stores access information for a Web page displayed on the display unit as history access information in the storage unit, the method comprising:
displaying the registration access information and the history access information stored in the storage unit on the display unit so as to be associated with each other.

13. A storage medium having a program stored thereon and readable by a computer of a communication device including a communication unit which accesses a Web site to receive data of a Web page, a display unit which displays the Web page based on the data received by the communication unit, a storage unit, a registration unit which stores access information for a Web page to be registered, as registration access information in the storage unit, and a history unit which stores access information for a Web page displayed on the display unit as history access information in the storage unit,
wherein when the program is executed by the computer, causing the computer to perform operations comprising:
displaying the registration access information and the history access information stored in the storage unit on the display unit so as to be associated with each other.
